(19) United States
(12) Patent Application Publication
(10) Pub. No.: US 2005/0224589 A1
(43) Pub. Date: Oct. 13, 2005

(54) SD memory card for extension of function

(75) Inventors: Young Soo Park, Daejeon-city (KR); Ji Man Park, Daejeon-city (KR); Young Sae Kim, Daejeon-city (KR); Sung Ik Jun, Daejeon-city (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/098,462

(22) Filed: Apr. 5, 2005

(30) Foreign Application Priority Data
Apr. 11, 2004 (KR) 10-2004-0089166

(51) Int. Cl. G06K 19/06

(52) U.S. Cl. 235/492

(57) ABSTRACT

Provided is a secure digital memory card for extension of function, including: a flash memory installed in a host device and storing data generated by the host device; a controller controlling an access interface to the flash memory; a radio frequency circuit performing functions of a contactless integrated circuit card and a contactless integrated circuit card reader through a wireless interface control of the controller; an antenna unit connected to the radio frequency circuit to perform a function of a transmission and reception antenna; and a contact integrated circuit card adapter performing the function of the contact integrated circuit card reader through a wire interface control of the controller.

### BACKGROUND OF THE INVENTION

This application claims the priority of Korean Patent Application No. 10-2004-0089166, filed on Nov. 4, 2004, in the Korean Intellectual Property Office, the disclosure of which is incorporated herein in its entirety by reference.

1. Field of the Invention

The present invention relates to an secure digital (SD) memory card for extension of function, and more particularly, to an SD memory card for extension of function, the SD memory card having functions of a contactless integrated circuit (IC) card and a contactless and/or contact IC card reader so as to be utilized in various application fields such as a traffic card, an access control, or the like based on its compact size, fast reading velocity, and large capacity.

2. Description of the Related Art

A contactless IC card includes a radio frequency (RF) module for processing an analog signal, a signal processing module for processing a contactless protocol and a digital interface signal, a central processing unit (CPU), a memory (a random access memory (RAM) or read-only memory (ROM), and the like.

The contactless IC card is classified into a contactless (closes coupling) IC card (CICC) and a remote coupling IC card which is classified into a proximity IC card (PICC), a vicinity IC card (VICC), and an RF IC card.

The CICC is standardized in ISO-10536. The PICC is standardized in ISO/IEC-14443, and the VICC is standardized in ISO-/IEC-15693. The CICC obtains a power source through capacitive coupling, and the remote coupling IC card obtains a power source through inductive coupling.

The contactless IC card does not to be inserted into a card reader and into an exact card position. Thus, the contactless IC card can be easily designed and manufactured. Also, a terminal can be firmly and inexpensively manufactured. Thus, maintenance cost can be reduced. In addition, the contactless IC card does not include a mechanical contact surface and thus is robust to static electricity, chemical damage, moisture, pollution, dust, friction, or the like. Thus, the contactless IC card can be used for a long period of time. Since a direct access to the contactless IC card is impossible, contents cannot be interpreted and thus cannot be forged.

Application fields of the contactless IC card include electronic cash, a traffic card, access control, fractional currency, and the like. In other words, the contactless IC card is used in a mobile phone, a physical distribution system, a vehicle control and a livestock identification card according to a system to which the contactless IC card is applied.

In a contactless and/or contact card reader, a contactless IC card reader supports physical characteristics and protocols (for an RF power source, a signal connection, initialization, and anti-collision) of a contactless IC card and communicates information to the contactless IC card by wireless.

The contactless card reader is classified into a simple card reader for simple communication between the contactless IC card and a system and a complex card reader performing an application without being linked to the system.

The simple card reader must satisfy ISO/IEC 14443 Types A and B and provides functions of a Type A and B compatible module, a CPU used for control, a memory storing programs and data, a key pad and a display used for a user, supporting of a hardware module such as a communication port for communication with an external source and applications, downloading of programs, and anti-collision.

The complex card reader is used for an EFT-POS, a Pay TV, a CD-ATM, a mobile terminal, and so on and provides applications through wire communication with a contact IC card.

The contact IC card reader for using the contact IC card satisfies ISO/IEC 7816 protocols and has similar functions to those of a contactless IC card reader except a wireless communication function.

An SD memory card is a kind of standard of a new compact SD memory card announced by the joint of Matsushita, SunDisk, and Toshiba in 2000 and includes a plurality of flash memories and one microprocessor chip manufactured by silicon semiconductor technology. The SD memory card is compact, light, and has fast storage and reading velocities and large capacity, and thus widely applied to computer peripheral devices, personal digital assistants (PDAs), digital cameras, digital workermans, or the like.

However, since the conventional SD memory card includes a plurality of flash memories and one microprocessor, the conventional SD memory card does not include wire and wireless interfaces performing functions of the above-described contactless IC card and the contactless and/or contact IC card reader and a control function. In order to include the functions of wire and wireless interfaces, the conventional SD memory card must include a controller chip for controlling the contactless IC card and the contactless and/or contact IC card reader and three or four controller chips for controlling an SD memory card interface and be controlled by each microprocessor. Thus, the conventional SD memory card is disadvantageous in terms of the installation of components.

### SUMMARY OF THE INVENTION

The present invention provides an SD memory card for extension of function, the SD memory card having functions of a contactless IC card (ISO 14443 Types A and B), a contactless IC card reader (Types A and B), and a contact IC card reader so as to provide a combination of the functions of the contactless IC card and the contactless IC card reader, and a controller for controlling the contactless IC card, the contactless and/or contact IC card reader, an SD memory card interface, and an access to a memory using one microprocessor.

The present invention also provides an SD memory card supporting a security mechanism such as an access control for restricting an access to files stored in a flash memory, encoding and decoding of the files, authentication of the files, or the like.

According to an aspect of the present invention, there is provided a secure digital memory card for extension of function, including: a flash memory installed in a host device and storing data generated by the host device; a controller controlling an access interface to the flash memory; a radio frequency circuit performing functions of a contactless integrated circuit card and a contactless integrated circuit card reader through a wireless interface control of the controller; an antenna unit connected to the radio frequency circuit to perform a function of a transmission and reception antenna; and a contact integrated circuit card adapter performing the function of the contact integrated circuit card reader through a wire interface control of the controller.

According to another aspect of the present invention, there is provided a secure digital memory card for extension of function, including: a flash memory installed in a host device and storing data generated by the host device; a controller controlling an access control to the flash memory; a radio frequency circuit performing functions of a contactless integrated circuit card and a contactless integrated circuit card reader through a wireless interface control of the controller; a first antenna connected to the radio frequency circuit and performing a function of a transmission and reception antenna; and an antenna connector connected to a second antenna installed outside the secure digital memory card and connected to the radio frequency circuit to perform a function of a reader transmission and reception antenna.

According to still another aspect of the present invention, there is provided a secure digital memory card for extension of function, including: a flash memory installed in a host device and storing data generated by the host device; a first controller controlling an access interface to the flash memory; a contact integrated circuit card adapter performing a function of a contact integrated circuit card reader through a wire interface control of the first controller; and a connector connected to an extension module performing functions of a contactless integrated circuit card and a contactless integrated circuit card reader and installed outside the secure digital memory card.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an SD memory card for extension of function according to an embodiment of the present invention;

FIG. 2 is a block diagram of an RF circuit shown in FIG. 1;

FIG. 3 is a block diagram of a card module shown in FIG. 2;

FIG. 4 is a block diagram of a reader module shown in FIG. 2;

FIG. 5 is a block diagram of an antenna unit shown in FIG. 1;

FIG. 6 is a block diagram of an SD memory card for extension of function according to another embodiment of the present invention; and

FIG. 7 is a block diagram of an SD memory card for extension of function according to still another embodiment of the present invention.

### DETAILED DESCRIPTION OF THE INVENTION

Hereinafter, an SD memory card for extension of function according to the present invention will be described in detail with reference to the attached drawings.

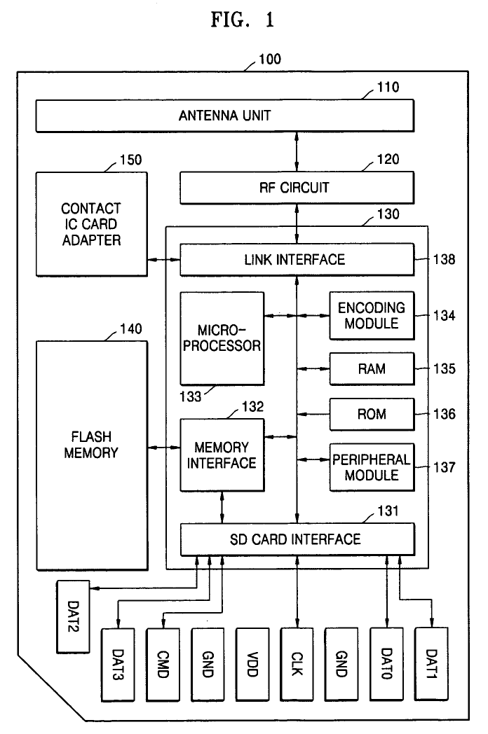

FIG. 1 is a block diagram of an SD memory card for extension of function according to an embodiment of the present invention. An SD memory card 100 has wire and wireless interface functions and performs wire and wireless communications using communication protocols of a contactless IC card and a contactless and/or contact IC card reader.

Referring to FIG. 1, the SD memory card 100 includes an antenna unit 110, an RF circuit 120, a controller 130, a flash memory 140, and a contact IC card adapter 150.

The RF circuit 120 is a wireless connection module for performing functions of a contactless IC card and a contactless IC card reader and connected to the controller 130.

The antenna unit 110 includes a signal transmission and reception antenna connected to the RF circuit 120 so that the RF circuit 120 performs a function thereof.

The controller 130 includes an SD card interface 131, a memory interface 132, a microprocessor (uP(RISC)) 133, an encoding module 134, a RAM 135, a ROM 136, a peripheral module 137, and a link interface 138.

The SD card interface 131 is connected to signal pines DAT0 through DAT3, GND, VDD, and CLK so as to be connected to a host device (for example, a laptop computer, a PDA, a mobile phone, a device with an SD memory card adapter, or the like) in which the SD memory card 100 is mounted.

The memory interface 132 is connected to the flash memory 140.

The encoding module 134 performs an encoding algorithm function for performing security functions such as encoding, decoding, and authentication for protecting data stored in a memory.

The RAM 135 performs a function of a work buffer memory used in the execution of a program.

The ROM 136 stores execution programs such as a program for controlling protocols of the contactless IC card and the contactless and/or contact IC card reader, a program for controlling the SD card interface 131, a program for controlling the encoding module 134, and the like.

The peripheral module 137 is used to perform and extend a function of the microprocessor 133 via a timer, a random number generator, or the like.

The link interface 138 links the RF circuit 120 and the contact IC card adapter 150 to the controller 130.

The microprocessor 133 executes the execution programs stored in the ROM 136 and controls higher protocols than the protocols of the contactless IC card and the contactless and/or contact IC card reader, the SD card interface 131, and a memory access to the flash memory 140. The microprocessor 133 controls the components of the controller 130 and controls the RF circuit 120 and the contact IC card adapter 150 via the link interface 138.

The flash memory 140 may be a flash ROM or an electrically erasable programmable ROM (EEPROM) used for an SD memory card and includes a system area, a project area, and a general user area.

The contact IC card adapter 150 is a wire connection module providing a wire physical contact point for using the contact IC card and connected to the controller 130.

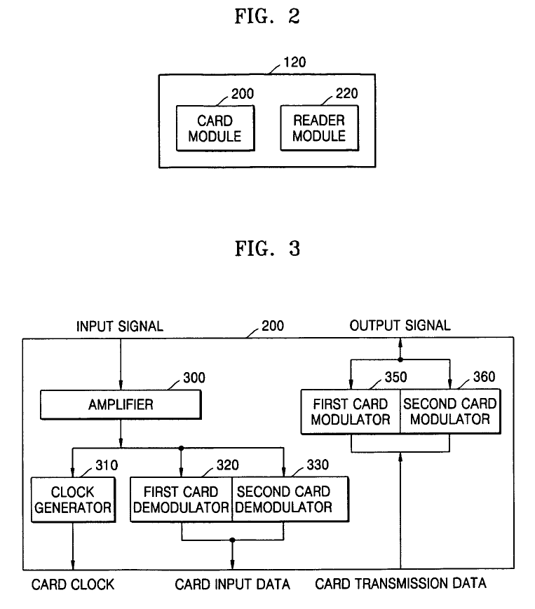

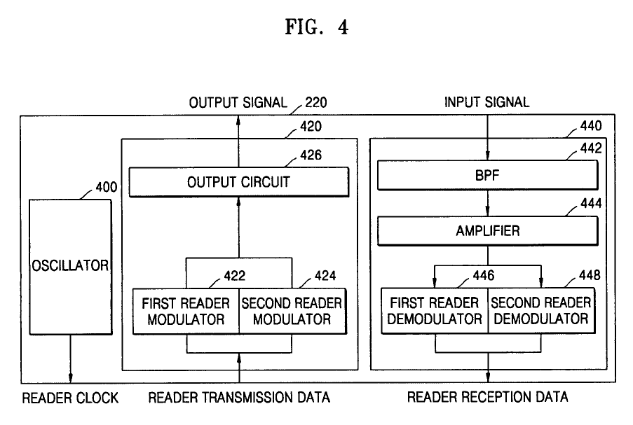

FIG. 2 is a block diagram of the RF circuit 120 shown in FIG. 1. Referring to FIG. 2, the RF circuit 120 includes a card module 200 performing the function of the contactless IC card and a reader module 220 performing the function of the contactless IC card reader. The card module 200 will be described with reference to FIG. 3, and the reader module 220 will be described with reference to FIG. 4.

FIG. 3 is a block diagram of the card module 200 shown in FIG. 2. Referring to FIG. 3, the card module 200 includes an amplifier 300 amplifying a signal input from an external apparatus via the antenna unit 110, a clock generator 310 receiving an output of the amplifier 300 to generate a card clock, a first card demodulator 320 (performing the function of the ISO/IEC 14443 Type A) and a second card demodulator 330 (performing the function of the ISO/IEC 14443 Type B) receiving the output of the amplifier 300 to extract card input data.

The card module 200 further includes first and second card modulators 350 and 360 (respectively performing the functions of ISO/IEC 14443 Type A and B) modulating card transmission data input from the controller 130 to convert the card transmission data into an output signal to be output to the external apparatus.

As shown in FIG. 3, the card module 200 includes the first and second card demodulators 320 and 330 and the first and second modulators 350 and 360 so as to constitute the SD memory card 100 including the contactless IC card satisfying the ISO/IEC 14443 Types A and B.

FIG. 4 is a block diagram of the reader module 220 shown in FIG. 2. Referring to FIG. 4, the reader module 220 includes an oscillator 400 generating a reader clock, a transmitter 420 converting reader transmission data into the output signal to transmit the output signal, and a receiver 440 receiving a reader input signal to convert the reader input signal into reader reception data.

The transmitter 420 includes first and second reader modulators 422 and 424 (performing the functions of the ISO/IEC 14443 Types A and B) modulating the reader transmission data input from the controller 130 and an output circuit 426 converting a reader modulation signal output from the first and second modulators 422 and 424 into the output signal and transmitting the output signal to the external apparatus.

The receiver 440 includes a band pass filter (BPF) 442 filtering and outputting only a signal in a predetermined band, of signals input from the external apparatus via the antenna unit 110 and outputting the filtered signal, an amplifier 444 amplifying the band signal output from the BPF 442, and first and second reader demodulators 446 and 448 (respectively performing the functions of the ISO/IEC 14443 Types A and B) demodulating the signal amplified by the amplifier 444 to generate the reader reception data and outputting the reader reception data to the controller 130.

As shown in FIG. 4 the reader module 220 includes the first and second modulators 422 and 424 and the first and second demodulators 446 and 448 so as to constitute the SD memory card 100 performing the function of the contactless IC card reader satisfying the ISO/IEC 14443 Types A and B.

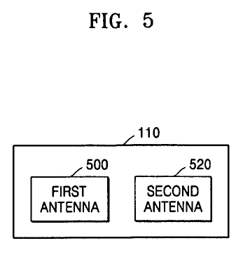

FIG. 5 is a block diagram of the antenna unit 110 shown in FIG. 1. Referring to FIG. 5, the antenna unit 110 includes first and second antennas 500 and 520 so as to support the functions of the contactless IC card and the contactless IC card reader.

As shown in FIG. 5, the antenna unit 110 includes the first and second antennas 500 and 520 to constitute the SD memory card 100 having the functions of the contactless IC card and the contactless IC card reader satisfying the ISO/IEC 14443 Types A and B.

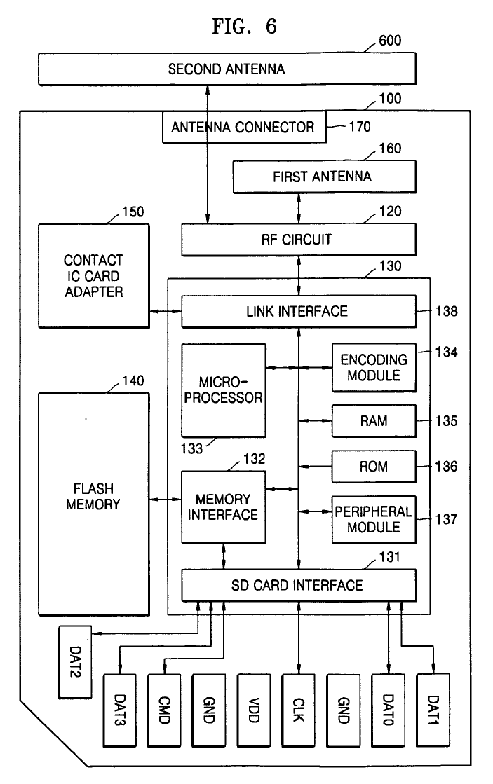

FIG. 6 is a block diagram of an SD memory card for extension of function according to another embodiment of the present invention. Referring to FIG. 6, unlike the antenna unit 110 shown in FIG. 1; an antenna unit shown in FIG. 6 includes a second antenna 600 connected to an RF circuit 120 via a first antenna 160 built in an SD memory card 100 and an antenna connector 170 of the SD memory card 100 and installed outside the SD memory card 100.

The other elements shown in FIG. 6 are denoted by the same reference numerals as those of the elements shown in FIG. 1, and thus undescribed elements are as described with reference to FIGS. 1 through 5.

In the present embodiment, the second antenna 600 is connected to the RF circuit 120 via the antenna connector 170. Thus, a wireless communication capacity of the SD memory card 100 shown in FIG. 6 can be further extended compared to the SD memory card 100 including two antennas as shown in FIG. 1 (or FIG. 5).

Also, in a case where the SD memory card 100 wireless communicates with a device at a predetermined distance therefrom, the second antenna 600 can more improve transmission and reception efficiency of an electric wave than when the second antenna 600 is installed in the SD memory card 100.

However, the structure in which the second antenna 600 is installed outside the SD memory card 100 may not be easily handled. Thus, in a case where a host device including the SD memory card 100 shown in FIG. 6 does not need the function of the contactless IC card reader, the second antenna 600 having a module structure may be separately used.

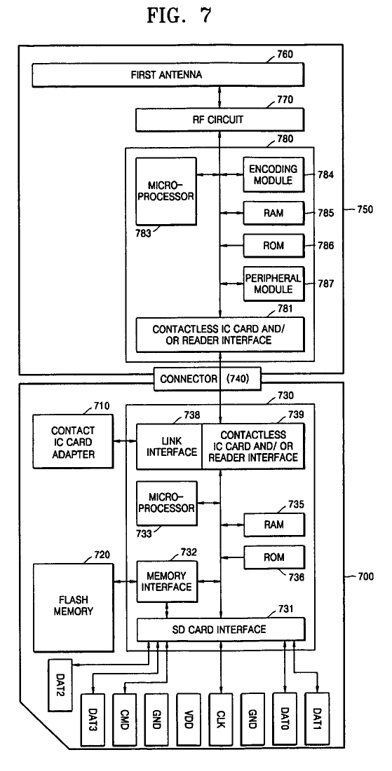

FIG. 7 is a block diagram of an SD memory card for extension of function according to still another embodiment of the present invention. Referring to FIG. 7, an SD memory card 700 is separated from a contactless IC card and contactless card reader function extension module 750.

The SD memory card 700 operates as a general SD memory card and includes a first controller 730, a flash memory card 720, a contact IC card adapter 710, and a connector 740 for connecting the SD memory card 700 to the contactless IC card and contactless card reader function extension module 750. The flash memory 720 may be a ROM or EEPROM used for an SD memory card and include a system area, a project area, and a general user area.

The contact IC card adapter 710 is a wire connection module providing a wire physical contact point for using the contact IC card and connected to the first controller 730.

The first controller 730 includes an SD card interface 731, a memory interface 732, a microprocessor (uP(RISC)) 733, a RAM 735, a ROM 736, a link interface 738, and a contactless IC card and/or reader interface 739.

The SD card interface 731 is connected to signal pines DAT0 through DAT3, GND, VDD, and CLK so as to be connected to a host device in which the SD memory card 700 is built.

The memory interface 732 is connected to the flash memory 720.

The RAM 735 performs a function of a work buffer memory used in the execution of a program.

The ROM 736 stores execution programs such as a program for controlling protocols of a contactless IC card and a contactless and/or contact IC card reader, a program for controlling the SD card interface 731, and the like.

The link interface 738 links the contact IC card adapter 710 to the first controller 730.

The microprocessor 733 executes the execution programs stored in the ROM 736 and controls higher protocols than the protocols of the contactless IC card and the contactless and/or contact IC reader, the SD card interface 731, and a memory access to the flash memory 720. The microprocessor 733 controls the components of the first controller 730 and controls the contact IC card adapter 710 via the link interface 738.

The first controller 730 has the same function as the controller 130 shown in FIG. 1 except that the first controller 730 includes the contactless IC card and/or reader interface 739 but does not include the encoding module 784 and a peripheral module 787.

The contactless IC card and/or reader interface 739 is connected to the contactless IC card and contactless IC card reader function extension module 750 via the connector 740.

The contactless IC card and contactless card reader function extension module 750 includes a first antenna 760, an RF circuit 770, and a second controller 780.

The RF circuit 770 is a wireless connection module performing the functions of the contactless IC card and contactless IC card reader and is connected to the second controller 780.

The first antenna 760 includes a signal transmission and reception antenna connected to the RF circuit 770 so that the RF circuit 770 performs a function thereof.

The second controller 780 controls the contactless IC card and the contactless IC card reader and includes a contactless IC card and/or reader interface 781, a microprocessor 782, the encoding module 784, a RAM 785, a ROM 786, and the peripheral module 787.

The encoding module 784 performs an encoding algorithm function for performing security functions such as encoding, decoding, and authentication of data, and the like for protecting data stored in a memory.

The peripheral module 787 is used to perform and extend a function of the microprocessor 783 using a timer, a random number generator, or the like.

Here, the contactless IC card and/or reader interface 781 is connected to the SD memory card 700 via the connector 740.

The second controller 780 is connected to the RF circuit 770. Here, the second controller 780 performs the same function as the first controller 730 except that the second controller 780 does not perform the functions of the contactless IC card and/or reader interface 781 and the flash memory 720 and thus will not be described in detail herein.

As shown in FIG. 7, the SD memory card 700 may be generally used an SD memory card device and may be connected to the contactless IC card and contactless card reader function extension module 750 including the second controller 780 performing the functions of the contactless IC card and contactless IC card reader, the RF circuit 770, and the first antenna 760 so as to extend a communication interface function.

As a result, components can be easily mounted in the SD memory card 700. Also, the SD memory card 700 can be arbitrarily to the contactless IC card and contactless card reader function extension module 750 to add a wireless interface function thereto.

In the embodiments described with reference to FIGS. 1, 6, and 7, a method of setting a host device connected according to the wire and wireless interface functions will now be described.

In a wire and wireless communication way of a contactless IC card and contactless and/or contact IC card reader, the contactless IC card and the contactless and/or contact IC card reader may mainly communicate with a specific one of devices within a communication range. In this case, the contactless IC card and contactless and/or contact IC card reader requires information for specifying a counterpart device to be connected. For example, the contactless IC card and the contactless and/or contact IC card reader registers their pin codes and a pin code of the specific device as set information in advance and communicates with the specific device based on the set information. The set information is stored in advance in a protection memory area of a flash memory.

Referring to FIG. 1, in the case of the SC memory card 100 shown in FIG. 1, set information recorded in a protection memory area of the flash memory 140 may be read according to the controller 130 that may control wire and wireless interfaces and a memory interface. The contactless IC card and the contactless and/or contact IC card reader can communicate with a specific counterpart device using the set information.

Only a specific host device having public key information can be accessed according to an authenticator of the SD memory card 100. Such an access control is performed to realize protection technology via an authenticator installed in a host device corresponding to the SD memory card 100. When data is read and written, the data is exchanged using encoding performed based on the public key information the host device and the SD memory card 100 commonly have. Thus, the access control is performed to prevent the data from being copied.

Thus, as described above, the SD memory card 100 can be installed in an arbitrary host device so as to communicate with a pre-set connection counterpart according to the host device. The SD memory card 100 must be installed in a specific host device to change the connection counterpart or read set information.

As described above, an SD memory card for extension of function according to the present invention can have wire and wireless interface functions. Thus, the SD memory card can be added to an information processor to be used for extension of function.

Also, the SD memory card can easily protect information using encoding and decoding and authentication functions by providing convenience of the SD memory card and an encoding module.

In addition, the SD memory card can include a combination of functions of a conventional contactless IC card and a conventional contactless and/or contact IC card reader. Thus, the SD memory card can be used in contactless IC card applications including a traffic card, access control, and the like.

Moreover, the SD memory card can uses the contactless IC card reader and the contact IC card reader as one. Thus, production cost can be reduced, and the contactless IC card reader and the contact IC card reader can be conveniently used and simply manipulated.

Furthermore, the SD memory card can include a multipurpose controller. Thus, the SD memory card can process information and include various applications such as functions of a storage memory, the contactless IC card and contactless and/or contact IC card reader, and the like. As a result, the SD memory card can be used as an application platform.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A secure digital memory card for extension of function, comprising:
a flash memory installed in a host device and storing data generated by the host device;
a controller controlling an access interface to the flash memory;
a radio frequency circuit performing functions of a contactless integrated circuit card and a contactless integrated circuit card reader through a wireless interface control of the controller;
an antenna unit connected to the radio frequency circuit to perform a function of a transmission and reception antenna; and
a contact integrated circuit card adapter performing the function of the contact integrated circuit card reader through a wire interface control of the controller.

2. The secure digital memory card of claim 1, wherein controller comprises:
a secure digital card interface providing an interface with the host device;
a memory interface providing an interface with the flash memory;
a link interface providing interfaces with the radio frequency circuit and the contact integrated circuit card adapter;
a read-only memory storing a program for controlling the functions of the contactless integrated circuit card and the contactless and/or contact integrated circuit card reader and programs for controlling the secure digital card interface, the memory interface, and the link interface; and
a microprocessor executing the programs stored in the read-only memory to control the functions of the contactless integrated circuit card and the contactless and/or contact integrated circuit card reader and controlling the secure digital card interface, the memory interface, and the link interface.

3. The secure digital memory card of claim 2, wherein the controller further comprises:
an encoding module performing an encoding algorithm function for protecting data stored in the flash memory,
wherein the read-only memory further stores a program for controlling the encoding module so that the microprocessor performs the encoding algorithm function.

4. The secure digital memory card of claim 3, wherein:
the flash memory stores set information via which the host device communicates with only a specific device, and
the controller authenticates only the specific device using the set information.

5. The secure digital memory card of claim 1, wherein the radio frequency circuit comprises:
a card module providing the function of the contactless integrated circuit card; and
a reader module providing the function of the contactless integrated circuit card reader.

6. The secure digital memory card of claim 5, wherein the card module comprises:
an amplifier amplifying a signal input from an external apparatus via the antenna unit;
a clock generator receiving an output of the amplifier to generate a card clock;
a card demodulator receiving the output of the amplifier to extract card input data input to the controller; and
a card modulator modulating card transmission data transmitted from the controller to generate an output signal and outputting the output signal to the external apparatus.

7. The secure digital memory card of claim 6, wherein:
the card demodulator comprises first and second card demodulators, and
the card modulator comprises first and second modulators.

8. The secure digital memory card of claim 5, wherein the reader module comprises:
an oscillator generating a reader clock;
a transmitter converting reader transmission data input via the controller into the output signal to transmit the output signal to the external apparatus; and
a receiver receiving the signal input via the antenna unit to convert the input signal into reader reception data.

9. The secure digital memory card of claim 8, wherein the transmitter comprises:
a reader modulator modulating the reader transmission data input from the controller; and
an output circuit converting a reader modulation signal output from the reader modulator into the output signal and outputting the output signal to the external apparatus.

10. The secure digital memory card of claim 9, wherein the reader modulator comprises first and second reader modulators.

11. The secure digital memory card of claim 8, wherein the receiver comprises:
a band pass filter filtering and outputting only a signal in a predetermined band, of input signals input from the external apparatus via the antenna unit;
an amplifier amplifying a band signal output from the band pass filter; and
a reader demodulator demodulating the signal amplified by the amplifier to generate the reader reception data and outputting the reader reception data to the controller.

12. The secure digital memory card of claim 11, wherein the reader demodulator comprises first and second demodulators.

13. The secure digital memory card of claim 1, wherein the antenna unit comprises first and second antennas built in the secure digital memory card.

14. The secure digital memory card of claim 1, wherein the antenna unit comprises:
a first antenna built in the secure digital memory card; and
a second antenna installed outside the secure digital memory card,
wherein the second antenna is connected to the radio frequency circuit via a connector.

15. A secure digital memory card for extension of function, comprising:
a flash memory installed in a host device and storing data generated by the host device;
a controller controlling an access control to the flash memory;
a radio frequency circuit performing functions of a contactless integrated circuit card and a contactless integrated circuit card reader through a wireless interface control of the controller;
a first antenna connected to the radio frequency circuit and performing a function of a transmission and reception antenna; and
an antenna connector connected to a second antenna installed outside the secure digital memory card and connected to the radio frequency circuit to perform a function of a reader transmission and reception antenna.

16. A secure digital memory card for extension of function, comprising:
a flash memory installed in a host device and storing data generated by the host device;
a first controller controlling an access interface to the flash memory;
a contact integrated circuit card adapter performing a function of a contact integrated circuit card reader through a wire interface control of the first controller; and
a connector connected to an extension module performing functions of a contactless integrated circuit card and a contactless integrated circuit card reader and installed outside the secure digital memory card.

17. The secure digital memory card of claim 16, wherein the extension module comprises:
a radio frequency circuit performing the functions of the contactless integrated circuit card and the contactless integrated circuit card reader;
an antenna unit connected to the radio frequency circuit and performing a function of a transmission and reception antenna; and
a second controller controlling a wireless interface so that the radio frequency circuit performs the function of the contactless integrated circuit card and the contactless integrated circuit card reader.

18. The secure digital memory card of claim 17, wherein each of the first and second controllers comprises a contactless integrated circuit card and/or reader interface.
